(19) United States
(12) Patent Application Publication
(10) Pub. No.: US 2004/0247954 A1
(43) Pub. Date: Dec. 9, 2004

(54) Method for controlling the methanol concentration in direct methanol fuel cells

(76) Inventors: Christian Ohler, Baden (CH); Thomas Christen, Birmenstorf (CH)

Correspondence Address: Daphne P Fickes, E I du Pont de Nemours & Company, Legal Patents, Wilmington, DE, 19898, US

(21) Appl. No.: 10/485,137

(22) PCT Filed: Jul. 12, 2002
(86) PCT No.: PCT/CH02/00382

(30) Foreign Application Priority Data
Jul. 27, 2001 (EP) 01810741.7

(51) Int. Cl. H01M 8/04

(52) U.S. Cl. 429/13; 429/23; 429/22

(57) ABSTRACT

The invention relates to a direct methanol fuel cell and to a method for controlling the methanol concentration without requiring the provision of additional methanol concentration sensors (47). Instead, the current-voltage characteristic curves of the fuel cell (40) are sampled using small variations of the system variables current I and methanol concentration M, and information used for controlling is obtained therefrom. In systems possessing an electrical buffer (49), a connected consumer is supplied without interruption despite the abandonment, as described by the invention, of the optimal operating point of the fuel cell.

### TECHNICAL DOMAIN

The present invention relates to the domain of direct methanol fuel cells (direct methanol fuel cells, DMFC). It concerns a process for the regulation of the methanol concentration in DMFC systems according to the preamble of claim 1, as well as a process for the determination of the methanol concentration in DMFCs according to the preamble of claim 9.

### STATE OF THE ART

As an alternative to fossil energy [fuel] carriers, methanol (CH₃OH) has an advantage, compared to hydrogen H₂, in that it is liquid under the usual environmental conditions and that the existing infrastructure for distribution and storage can be used. In addition, the safety requirements are considerably more favorable than with hydrogen. Although it is entirely possible to generate hydrogen from methanol for use in hydrogen fuel cells directly at the site of use itself by reforming, the process is associated with a delayed cold-start behavior.

In so-called direct methanol fuel cells (direct methanol fuel cells, DMFC) methanol is directly electrochemically oxidized, that is, without the prior intermediate step of reforming to H₂. In general one works with a dilute methanol solution, where the solution circulates and the concentration desired for optimal operation is regulated by the addition of concentrated methanol. To achieve this, it is necessary in the state of the art to in each case know the current concentration of the solution. For this purpose, different processes are known, which use sensors that have to be additionally installed, such as high precision density sensors that, if they fail, make the entire fuel cell system inoperative.

In DE-A 199 38 790, the methanol concentration is determined by measuring the capacity of a capacitor, with the solution being used as a dielectric, and by obtaining from that measurement the dielectricity constant of the solution, and from whose monotonic concentration dependency, the methanol concentration is determined. To achieve the required dissolution, it is proposed to provide, in addition, a reference capacitor with a dielectric in the desired concentration range of the methanol solution.

In another sensor, a voltage is applied between two electrodes of a small, separate electrochemical cell, so that methanol is oxidized at one electrode and hydrogen ions are reduced at the other electrode. This cell is operated in such a manner that the current flowing in the electrical cell is limited due to the kinetics of the mass transport; thus, it is dependent on the methanol concentration. Analogous processes are also used for the determination of the alcohol content in human respiration air.

### DESCRIPTION OF THE INVENTION

The problem of the present invention is to create a process for the regulation of the methanol concentration of a direct methanol fuel cell system, which makes it possible to omit the additional methanol concentration sensors and which is accordingly cost-advantageous. This problem is solved by a regulation process having the characteristics of claim 1.

The core of the invention is that, in the context of a fuel cell, it is not based a comparison between the absolute desired and actual concentration values of the fuel solution; instead, it is based on sensing, at least in sections, the parameter lines of the voltage that are characteristic for the fuel cell, as a function of system parameters such as the current strength or current density, or as a function of the methanol concentration. The change in voltage, which is observed as a result of the variation of a system parameter, is here employed for the regulation of the methanol concentration, that is, used in the decision whether, and if so how much, concentrated methanol should be added to the fuel solution. The invention is based on the observation that most system parameters, such as the temperature of the fuel solution, the flow rates of the reactants, the pressure of the gaseous reactants, or the quantity of catalyst material, can either be determined in a simple manner and directly in a known manner, or they are already known. By comparison, the methanol concentration is the system parameter that represents the most expensive one to determine the parameter of the current-voltage characteristic lines of the fuel cell, and thus it is best determined indirectly from its influence on precisely the voltage characteristic lines.

In a first embodiment of the regulation process according to the invention, known processes are therefore used to test whether one of the directly determinable system parameters has changed and whether the measured voltage may possibly misrepresent the change in the methanol concentration. The difficulty in determining the degree of clogging of the cathodic electrode pores with water is an additional system parameter. To minimize its influence, the cathodic air addition [on the cathode side] is increased during the regulation process.

According to an additional embodiment, the response of the system to a variation in the current strength is determined in the form of a current-voltage characteristic line section. This can be carried out, for example, at predetermined time intervals, and, in particular, also when the operating parameters do not yet give any sign of a decrease in the methanol concentration. Mathematical processes make it possible to evaluate this characteristic line section, to localize characteristic points of the characteristic line, and to determine the methanol concentration by comparison with tabulated values.

As an alternative, the methanol content can also be changed from an unknown actual or starting value, by a known level, while the current strength is maintained constant. The regulation intervention by trial is triggered in particular if, based on an observed decrease in the voltage, there is a suspicion that a methanol reduction has occurred. If, subsequently, the voltage rises again, a first step in the right direction has already been accomplished, which then is reinforced by further methanol additions, if applicable; otherwise, the cause of the voltage drop must be sought elsewhere.

In the case of the stacking of several, bipolar arranged, series-connected fuel cells, which are all fed with the same fuel solution, one can directly assume that the voltage is the voltage of the entire stack. The proposed regulation process is particularly advantageous in a system with an electric intermediate tank unit [battery] because a deviation of the system parameters from the optimal operation point occurs during the regulation process, while the intermediate tank unit ensures an uninterrupted and constant supply of a consumable [source of energy].

Advantageous embodiments are the object of the dependent claims.

### BRIEF DESCRIPTION OF THE FIGURES

The invention is further explained below with reference to embodiment examples in connection with the drawings. In the drawings:

FIG. 1 shows a cross section through a direct methanol fuel cell,

FIG. 2 shows the voltage curves of a direct methanol fuel cell,

FIG. 3 shows the current-voltage characteristic lines for different methanol concentrations, and

FIG. 4 shows a diagram of a fuel cell system.

The reference numerals used in the drawings are summarized in the reference numeral list. In addition, identical parts are identified by the same reference numerals.

### MEANS TO CARRY OUT THE INVENTION

Detailed indications regarding the construction and the process of operation of direct methanol fuel cells can be obtained, for example, from the article by M. Baldauf et al. “Direct methanol fuel cells,” published in “Brennstoffzellen [Fuel cells],” K. Ledjeff-Hey et al. (Editors), C. F. Müller Verlag, Heidelberg, 2001, pp. 77-100. This topic will only be discussed in summary below.

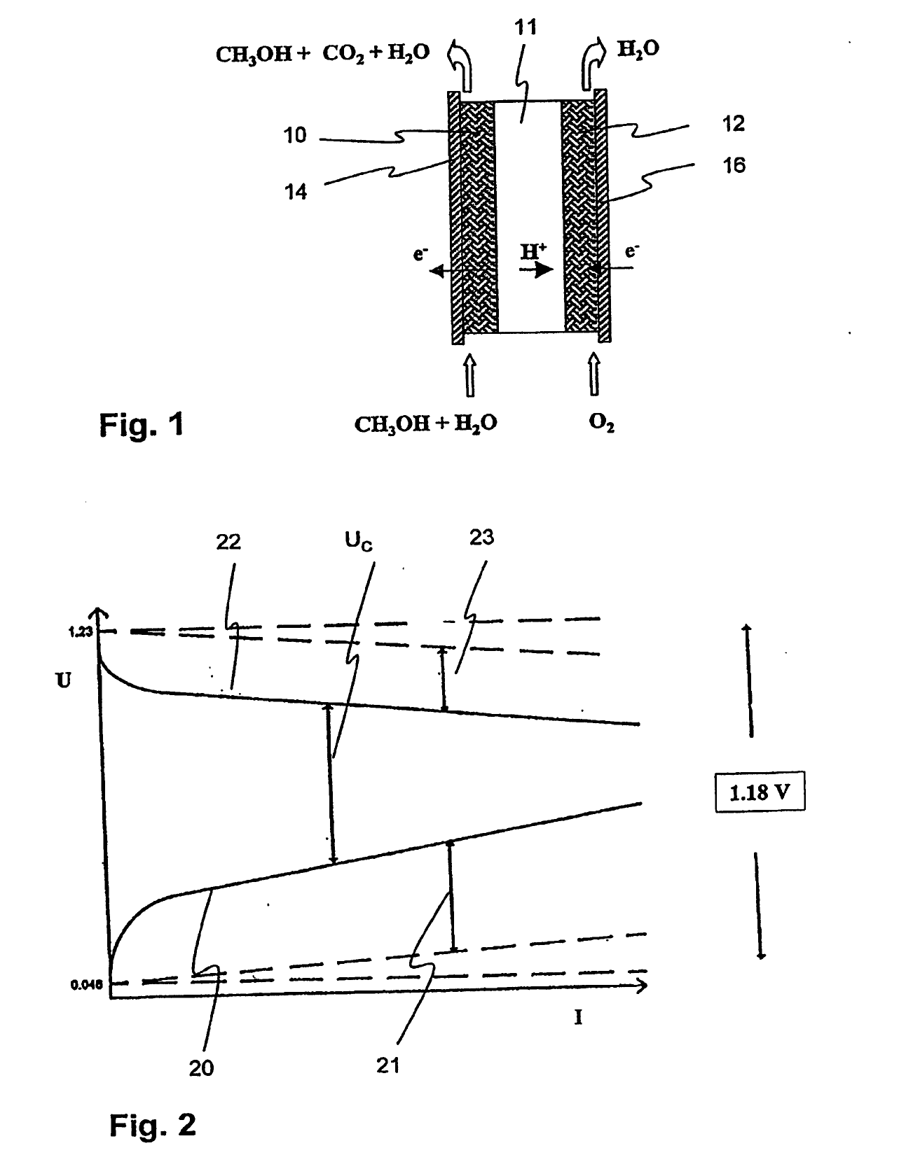

FIG. 1 is a schematic representation of the construction of a so-called membrane fuel cell 1. The latter consists of, between an anode 10 and a cathode 12, an appropriate proton-conducting solid electrolyte 11, for example, a 100-μm-thick humidified polymer membrane. The electrodes 10, 12 have an open pore structure, preferably with openings in the nanometer range, and they consist of an electrically conducting material, typically carbon fibers, which are covered with catalysts such as Pt or Pt/Ru, which are not shown in FIG. 1. The electrodes 10, 12 make contact, on their side which is turned away from the electrolyte 11, in each case with a current collector 14, 16 made of a carbon-based material. The contacting of the electrodes 10, 12 must be equally good on both sides, so that the protons H⁺ and the electrons e⁻ can be removed and supplied, respectively, without problems. The reactants CH₃OH, H₂O, and O₂, or air, are supplied through the pores of the electrodes 10, 12, with such pores forming a gas diffusion layer, and the products CO₂ and H₂O are removed.

The electrochemical oxidation of methanol, in the case of a complete reaction, yields six electrons e⁻ per formula unit, according to the following simplified partial reactions:

Anode: CH₃OH+H₂O→CO₂+6H⁺+6e⁻

Cathode: 3/2 O₂+6H⁺+6e⁻→3 H₂O

Total: CH₃OH+3/2 O₂→CO₂+2 H₂O

FIG. 2 represents separate voltage curves of the anode 20 and cathode 22 of a DMFC. The cell voltage U_{C} of an actual cell is the difference between the voltage of the anode and that of the cathode at a given current I, and corresponds to the difference between the standard voltages E₀ of the two electrode reactions (1.18 V) only in the current-free state. If a current I flows through the cells, the voltage curves of the anode 20 and cathode 22 come closer to each other because of the losses that occur. The latter represent, on the one hand, the so-called kinetic losses of the anode 21 and cathode 23 due to reaction excess voltages at the electrodes as well as due to ohmic losses in the electrolytes, which can be seen in the linear decrease in the cell voltage U_{C} at higher current strengths I.

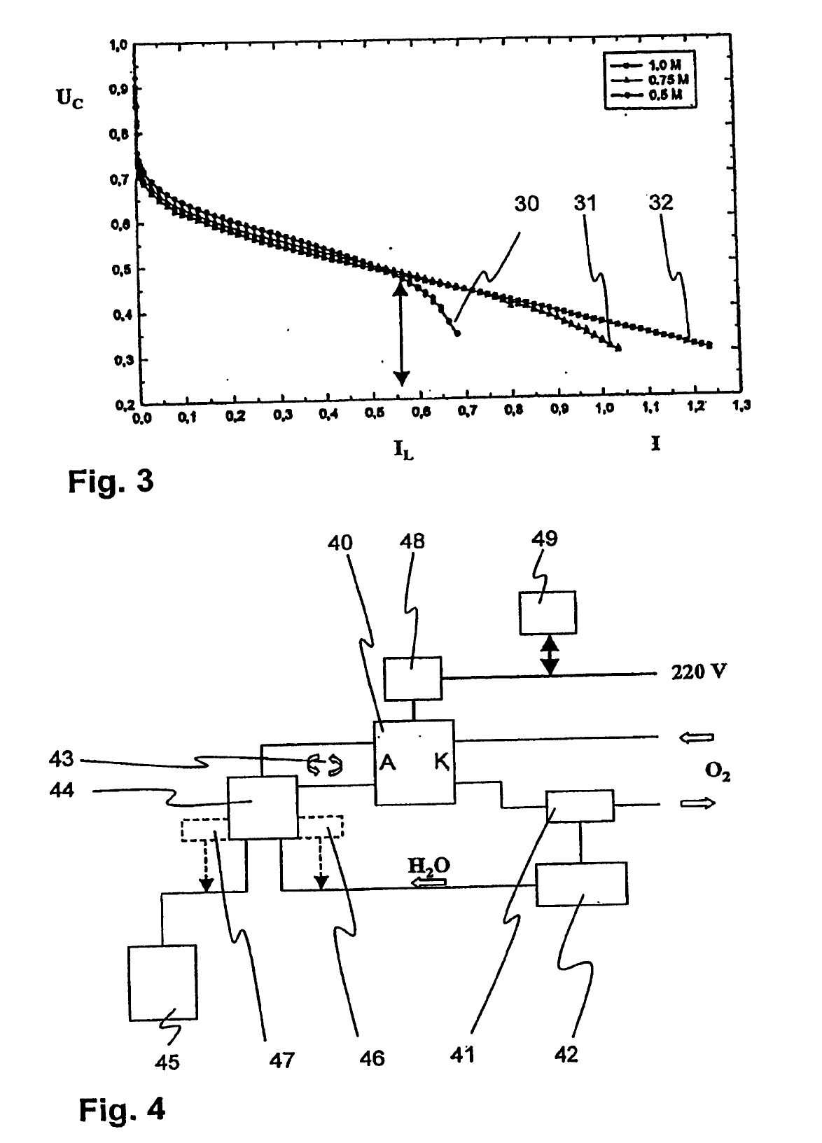

FIG. 3 represents a typical course of a group of three current-voltage characteristic lines 30, 31, 32 with different methanol concentrations M (M30: 0.5 molar, M31: 0.75 molar, M32: 1 molar) where other system parameters and/or operating conditions remain the same. Starting at a certain current strength, the methanol concentration M in the anodic operational [work] layer is no longer sufficient, so that the decrease of the cell voltage U_{C} is disproportionally high at even higher current strengths. For the lowest methanol concentration (characteristic line 30) one can, accordingly, see a clear deflection in the characteristic line at a limit current strength I_{L}.

The clogging of the cathode-side gas diffusion layer, or the pores, by water droplets represents a problem with DMFC. The water diffuses as a hydrate sheath with the protons H⁺ through the electrolyte (electro-osmosis) or it is generated by the cathode reaction. As a result, it becomes more difficult for the oxygen to reach the active electrode surface, and the electrical output generated by the cell decreases. Another problem with the principle [of the DMFC] is the methanol diffusion through the solid electrolyte, which increases with a greater methanol concentration M. If current flow exists, the methanol is indeed transported to the cathode because methanol, just like water, solvates the proton H⁺. In the process, methanol is oxidized at the cathode, leading to an appreciable decrease in the electrode voltage at the cathode, that is, the formation of a mixed voltage. Thus, the supply of the anode with methanol should be adjusted in such a manner that, on the one hand, the concentration at the anodic operational layer is as optimal as possible for the catalyst, and, on the other hand, so that the described methanol diffusion remains within an acceptable range.

To generate higher voltages, in practical [useable] fuel cell systems, several fuel cells are connected in a bipolar series arrangement and are contacted only on the front side. The current collectors 14, 16 between two adjacent fuel cells in this case are not replaced by bipolar plates that consist, for example, of graphite, and which at the same time fulfill the function of reactant supply by means of corresponding channels. In the process, the fuel solution is led in parallel to the cells, so that the methanol concentration is approximately the same in all areas.

FIG. 4 shows a fuel cell system with a fuel cell stack 40, which is provided, in particular, for a self-sufficient (stand alone) operation. On the cathode side, oxygen O₂, preferably as a component of air, is introduced by means of a ventilator, which is not shown. The water present in the exhaust is again separated out in a capacitor 41 and led to a water tank 42. The anode-side fuel solution is circulated in an anode [anodic] circulation 43, which also includes a fuel solution reservoir 44 as a buffer. Both the water and the fuel solution are moved by pumps, which are not shown. Since the electrochemical reaction in the fuel cells 40 consumes methanol and, as discussed, the latter diffuses through the electrolyte, the fuel solution reservoir 44 must be replenished with concentrated methanol from a methanol tank 45 and with water from the water tank 42. Only the methanol tank 45 must be periodically replenished from the outside in this stand-alone system.

On the front side of the fuel cell stack 40, or of its external current collectors, a current circuit is electrically connected with a consumption [consumer-associated] device, which is not represented. The current circuit preferably consists of a direct-current-alternating-current inverter or rectifier 48 that converts the voltage of the system to a desired level of, for example, 220-V alternating current. An intermediate tank 49, in the form of a battery, ensures a sufficient output at peak loads. In this configuration, the consumer is always supplied with current even if there is a brief stoppage of the fuel cell system.

Neither the methanol consumption nor the rate of the above-mentioned diffusion of water out of the anode circulation to the cathode are entirely known and, in addition, they change with the load, or the drawn power, respectively. For that reason, one must first monitor the filling level of the fuel solution in the solution reservoir using a level sensor 46 and, second, the correct methanol concentration must be maintained, typically at 0.5-5 wt %. A replenishment of the fuel reservoir occurs by the addition of water from the water tank 42.

According to the invention, one now does not need an additional sensor 47 to measure the current actual value, for the purpose of regulating the methanol concentration M; instead, the fuel cell itself is used to perform at least a qualitative correction of the methanol concentration. In this process, during the operation of the system, the reaction of the cell voltage U_{C} or, in the case of a fuel cell stack, the total system voltage U, is examined, with such a reaction occurring as a result of a variation of one of the two system parameters—current strength I or current density, respectively, or due to variation of the methanol concentration M.

For example, during the operation of the system, one periodically senses—at an interval of typically 10 min—the current-voltage characteristic line for a few seconds. Since the optimal operation point of the system, defined by current and voltage in continuous operation, is located in the vicinity of the deflection at I_{L}, which is associated with the desired methanol concentration, the latter deflection is detected in the process. If the limit current strength I_{L}, that is, the transition to the mass transport-limited anode-side reaction rate, now has shifted in comparison to the last sensing, one can conclude therefrom that there has been a change in the methanol concentration M. In particular, if the difference between the limit current strength I_{L} and the operation [focal] point has become smaller or even negative, this finding is equivalent to a decrease in the methanol concentration M, so that the addition of a certain quantity of methanol ΔM is required.

On the other hand, the mentioned limit current strength I_{L}, as the site of the maximum of the second derivation of the U(I) characteristic line, can also be localized as precisely as possible, for example, using any desired mathematical complex interpolation procedures. For this purpose, it can be advantageous to first subtract the linear part of the current-voltage characteristic line, which changes with the electrical resistance, and thus the age of the polymer membrane, among other factors. Furthermore, one should take into account the possibility of a dependency of the characteristic line on the speed with which it has been sensed. From the exact knowledge of the limit current strength, one can determine the associated concentration M by comparison with tabulated values.

To increase the temporal separation between the mentioned sensing operations, one can also use model calculations based on the integrated cell current and the Faraday law, as well as estimates of the diffusion of methanol through the membrane. Also, one can carry out an estimate of the methanol consumption and periodically replenish the methanol. The proposed sensing operations in this case serve to calibrate the process by eliminating the unavoidable deficiencies of the model used or deficiencies of its parameters.

As an alternative to the above described process, it is also possible to increase the methanol concentration to a certain value, based on speculation, in particular if a decrease in the voltage has already been observed at the operation point. Such a decrease, as is known, can be caused by a change of any system parameter. For example, if following the methanol addition ΔM, the voltage U recovers again, one can then assume that there has in fact been a reduction in the methanol concentration. If not, one must look elsewhere for the cause. However, it is preferred to first examine the other system parameters, such as the temperature T of the fuel solution, the partial pressure of the oxygen p, or the oxygen flow rate F.

To ensure that an observed decrease in voltage has not been caused on the cathode side by a mass transport limitation of the gaseous reactants or by the described clogging of the electrode pores by water droplets, it is possible to temporarily increase the cathodic gas throughflow during the sensing. However, to achieve this, the ventilator used [for such a purpose] consumes energy, so that this approach would worsen the energy balance sheet of the system.

Although the present invention has been described using the example of a direct methanol fuel cell, it is clear that it can also be applied to fuel cells that oxidize, directly on the anode side, the hydrogen or other hydrocarbons, such as methane, propane, or ethanol. This applies to the case in which these gaseous or liquid reactants are not in pure form but in the form of a mixture, for example, with nitrogen as an inert gas.

Reference Numeral List

1 Membrane fuel cell

10 Anode

11 Solid electrolyte

12 Cathode

14, 16 Current collector

20 Voltage curve of the anode

21 Voltage decrease at the anode

22 Voltage curve of the cathode

23 Voltage decrease at the cathode

30, 31, 32 Current-voltage characteristic lines

40 Fuel cell stack

41 Capacitor

42 Water tank

43 Anode circulation

44 Fuel solution reservoir

45 Methanol tank

46 Fuel level sensor

47 Methanol concentration sensor (state of the art)

48 Direct-current-alternating-current inverter

49 Intermediate tank unit

U_{C} Cell voltage

I_{L} Limit current strength

1. Process for the regulation of the methanol concentration (M) of a direct methanol fuel cell system having at least one fuel cell and a separate methanol reservoir (45), where the fuel cell is characterized by the characteristic lines (30, 31, 32) of a voltage (U) as a function of the system parameters—current strength (I) and methanol concentration (M)—as well as of other system parameters (T, p, F),
characterized in that the current strength (I) is varied and that methanol is added from the methanol reservoir (45) as a function of the resulting voltage (U) of the fuel solution.

2. Regulation process according to claim 1, characterized in that, prior to said variation in the current strength (I), the other system parameters (T, p, F) are examined for any changes that have occurred.

3. Regulation process according to claim 1, characterized in that, during said variation, the gas throughflow on the cathode side is increased.

4. Regulation process according to one of claims 1-3, characterized in that the current strength (I) is varied in a certain range and a current-voltage characteristic line section is determined.

5. Regulation process according to claim 4, characterized in that said variation of the current strength (I) occurs at predetermined time intervals.

6. Regulation process according to claim 4, characterized in that said variation of the current strength (I) occurs after an observed voltage decrease.

7. Regulation process according to one of the preceding claims, where the fuel cell system consists of a stack (40) of at least two fuel cells that are in bipolar arrangement and electrically series-connected,
characterized in that the voltage (U) is the total voltage of the fuel cell stack (40).

8. Regulation process according to claim 1 or 7, where the fuel cell system, during normal operation, feeds electrical energy into an intermediate tank unit (49), from which a consumer in turn is supplied [with energy or current],
characterized in that, at said variation of the current strength (1), the consumer is supplied without interruption by the intermediate tank unit (49).

9. Process for the determination of a methanol concentration in a direct methanol fuel cell, which is characterized by the characteristic lines (30, 31, 32) of the voltage (U) as a function of the system parameters—current density (I) and methanol concentration (M)—as well as additional system parameters (T, p, F),
characterized in that, by a variation of a system parameter (I; M) and simultaneous measurement of the voltage (U), a characteristic line section is determined, from which a value (I_{L}) is derived by appropriate mathematical analyses, from which in turn the methanol concentration (M) is determined by comparison with tabulated values.
